(19) United States
(12) Patent Application Publication
(10) Pub. No.: US 2024/0338296 A1
(43) Pub. Date: Oct. 10, 2024

(54) EFFICIENT FIRMWARE TESTING

(71) Applicant: Dell Products L.P., Round Rock, TX (US)

(72) Inventors: Xiaowei SHEN, Shanghai (CN); Trevor ZHENG, Shanghai (CN); Xiaoxuan DONG, Shanghai (CN); Jinghui ZHANG, Shanghai (CN)

(73) Assignee: Dell Products L.P., Round Rock, TX (US)

(21) Appl. No.: 18/307,342

(22) Filed: Apr. 26, 2023

(30) Foreign Application Priority Data
Apr. 4, 2023 (CN) 202310359243.3

(51) Int. Cl. G06F 11/36

(52) U.S. Cl. CPC G06F 11/3636

(57) ABSTRACT

Disclosed methods for testing information handling system software identify trace points, test cases, and test resources for testing firmware or another type of software and perform a full regression of the software to obtain test information including coverage information indicative of traces points reached by each test case and test duration information indicative to time required to perform each test case, wherein the full test include performing each test case on each test resource. Based on the test information, optimized test case test resource (TCTR) tuples are determined for efficiently testing the software. The optimized TCTR tuples, when executed, achieve greater coverage per time interval than the full test. Performing the full regression test may include executing each test case on each testing resource.

### TECHNICAL FIELD

The present disclosure pertains to information handling systems and, more specifically, testing of firmware for information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Many information handling systems may be characterized as state machines in which the state of the system transitions from one state to the next in a consistent and predictable manner in response to changes in the system's inputs. Such systems may load and execute firmware to initialize the system to a known initial state. Accordingly, it is imperative that firmware functionality be comprehensively tested before the firmware is released and deployed to end user systems. Generally, however, the enormous number of theoretically possible states and input combinations that a firmware release for a system of even modest complexity might experience is far too great to fully test within any reasonable time constraint. As a result, firmware testing typically involves a tradeoff between test coverage, indicative of the percentage of states tested, and test time. For example, the time required to validate a firmware release across different platforms and system types on real testbeds with different hardware configurations may be measured in terms of days. In addition, test time may be further impacted due to a scarcity of shared testing resources including, as illustrative examples, preboot execution environment (PXE) servers, debugging toolkits (DTK), oscilloscopes, test chambers, etc.

### SUMMARY

Technical advantages of the present disclosure may be readily apparent to one skilled in the art from the figures, description and claims included herein. The objects and advantages of the embodiments will be realized and achieved at least by the elements, features, and combinations particularly pointed out in the claims.

In at least one aspect, disclosed methods for testing information handling system software identify trace points, test cases, and test resources for testing firmware or another type of software and perform a full regression of the software to obtain test information including coverage information indicative of traces points reached by each test case and test duration information indicative to time required to perform each test case, wherein the full test include performing each test case on each test resource. Based on the test information, optimized test case test resource (TCTR) tuples are determined for efficiently testing the software. The optimized TCTR tuples, when executed, achieve greater coverage per time interval than the full test. Performing the full regression test may include executing each test case on each testing resource. Determining the optimized TCTR tuples may include defining matrix representations of the testing resources, the test coverage, and the test duration, calculating a coverage score and test duration for each TCTR tuple, and identifying the optimized TCTR information based on the coverage scores and test durations. Determining the optimized TCTR tuples includes determining TCTR tuples that produce the highest coverage score for a specified maximum duration. Determining the optimized TCTR tuples include determining TCTR tuples producing the lowest test duration for specified minimum test coverage.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a flow diagram of a testing method;

FIG. 2 depicts exemplary data structures for an efficient testing method;

FIG. 3 depicts the data structures of FIG. 2 facilitating the determination of optimized TCTR tuples;

FIG. 4 illustrates an exemplary testing resource;

FIG. 5 illustrates an equation for generating a test coverage score;

FIG. 6 illustrates an equation for generating a test duration value;

FIG. 7 depicts a maximum time duration determination; and

FIG. 8 depicts a determination of a test coverage score;

FIG. 9 illustrates constraint-limited optimizations of test coverage and test duration in accordance with disclosed teachings;

FIG. 10 illustrates an information handling system suitable for use in conjunction with FIGS. 1-9; and

FIG. 11 illustrates a test configuration employing shared testing resources; and

FIG. 12 illustrates a testing resource matrix for the shared testing resource configuration of FIG. 11.

### DETAILED DESCRIPTION

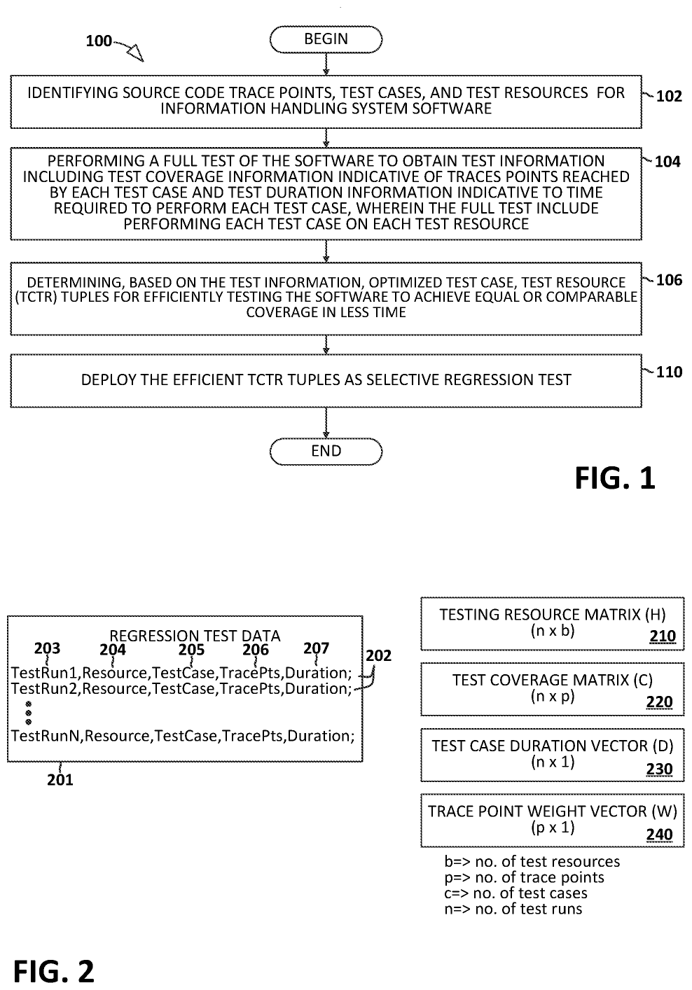

Exemplary embodiments and their advantages are best understood by reference to FIGS. 1-12, wherein like numbers are used to indicate like and corresponding parts unless expressly indicated otherwise.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”), microcontroller, or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

Additionally, an information handling system may include firmware for controlling and/or communicating with, for example, hard drives, network circuitry, memory devices, I/O devices, and other peripheral devices. For example, the hypervisor and/or other components may comprise firmware. As used in this disclosure, firmware includes software embedded in an information handling system component used to perform predefined tasks. Firmware is commonly stored in non-volatile memory, or memory that does not lose stored data upon the loss of power. In certain embodiments, firmware associated with an information handling system component is stored in non-volatile memory that is accessible to one or more information handling system components. In the same or alternative embodiments, firmware associated with an information handling system component is stored in non-volatile memory that is dedicated to and comprises part of that component.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically. Thus, for example, “device 12-1” refers to an instance of a device class, which may be referred to collectively as “devices 12” and any one of which may be referred to generically as “a device 12”.

As used herein, when two or more elements are referred to as “coupled” to one another, such term indicates that such two or more elements are in electronic communication, mechanical communication, including thermal and fluidic communication, thermal, communication or mechanical communication, as applicable, whether connected indirectly or directly, with or without intervening elements.

Referring now to the drawings, FIG. 1 depicts a flow diagram of a method 100 for testing information handling system software including, but not limited to, regression testing firmware for an information handling system platform. For the sake of clarity and brevity, the following description may refer primarily or exclusively to firmware while, but those of ordinary skill in the field will readily appreciate that disclosed features are suitable for other types of software as well.

The method illustrated in FIG. 1 begins by identifying (operation 102) trace points, test cases, and test resources for testing firmware or another type of software product. Trace points and test cases may be identified or otherwise determined in any suitable manner and the specifics of how trace points are identified are outside the scope of the present disclosure.

The method 100 illustrated in FIG. 1 further includes performing (operation 104) a full regression test, also referred to herein more simply as a full test, to obtain test information from which optimized test-case, test-resource tuples can be determined for subsequent deployment. In at least some embodiments, the full regression test includes executing every test case on every available test resource. Test resources may include fully-provisioned testbeds that can execute test cases independently and do not require any share testing resources including, as non-limiting examples, an Intel Debug Toolkit (IDT), a Pre-boot execution environment (PXE) server, oscilloscopes, test chambers, and the like. The use of shared resources is illustrated and discussed in more detail with respect to FIG. N below. For improved clarity and brevity, however, at least some of the drawing figures and corresponding descriptions illustrates exemplary implementations in which each test resource is an independent and fully functional testbed wherein each testbed is functional to execute any of the required test cases. For deployments that employ fully-functional testbeds exclusively, the number of TCTR tuples is equal to the product of the number of test resources and the number of test cases.

The test information generated during the full regression may include test duration information, indicative of the duration of each instance of a test run, where a test run refers to a test case instance executed on a particular test resource, coverage score information indicative of each test run's success at achieving the predetermined set of trace points, and test resource information indicative of the testing resource that performed a particular test run.

The method 100 illustrated in FIG. 1 further includes determining (operation 106), based on the test information, optimized TCTR tuples for efficiently testing the firmware or other software. In some implementations, the optimized TCTR tuples correspond to the test case and test resource combinations that achieve the highest test coverage score subject to a specified test time duration limit. In some implementations, the optimized TCTR pairs may correspond to test case and test resource combinations that achieve a coverage score equal or comparable to a coverage score of the full regression, while requiring appreciably less test time. Having determined optimized TCTR tuples, the illustrated method 100 then deploys (operation 110) the identified tuples as a selective regression test. For example, the selective regression test might be performed on a weekly or even daily basis.

Turning now to FIG. 2, exemplary data structure aspects of the optimized TCTR process of FIG. 1 are depicted. The test information acquired by performing a full regression test as discussed above with respect to FIG. 1 is illustrated in FIG. 2 as regression test data 201. Regression test data 201 is depicted in FIG. 2 as a plurality of regression test entries 202, each of which includes a test run identifier 203, test resource information 204, a test case identifier 205, test coverage information 206 indicative of traces points achieved, and duration information 207 indicating the time required to complete the test run.

FIG. 2 further depicts regression test data 201 as the source for creating matrix representations of the regression testing. The matrix representations facilitate the identification of TCTR tuples as described in more detail below. The matrices illustrated in FIG. 2 include a testing resource matrix 210, a test coverage matrix 220, a test run duration matrix 230, and a trace point weighting matrix 240. The testing resource matrix 210 illustrated in FIG. 2 is an n×b matrix, i.e., n rows and b columns, wherein n indicates the number of test runs and b indicates the number of testing resource. The illustrated test coverage matrix 220 is an n×p matrix where p represents the number of trace points. The illustrated test case duration matrix 230 is illustrated as an n×1 matrix, i.e., a vector of dimension n, and trace point weighting vector 240 is a p×1 matrix, i.e., a vector of dimension p. For embodiments in which the test resources do not include shared resources, i.e., independently functional testbeds, the value of n, the number of test runs, equals the product of C, the number of test cases, and b, the number of test resources. i.e., n=b×c.

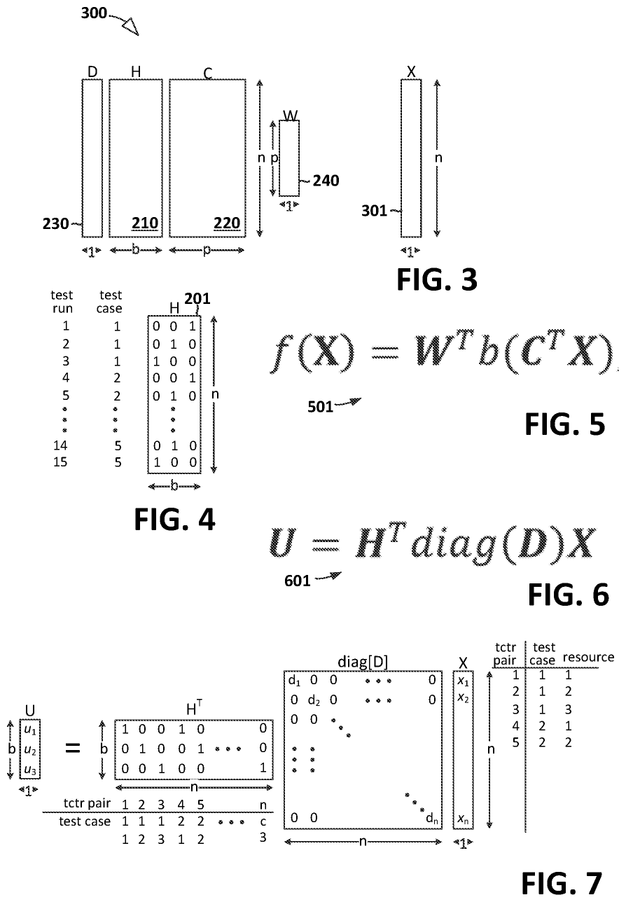

FIG. 3 illustrates the regression test matrices of FIG. 2 including testing resource matrix 210, 210, 220, 230, and 240 from which a matrix representation of the optimized TCTR tuples is determined 301. The TCTR matrix 301 illustrated in FIG. 3 is an n×1 matrix, i.e., a vector of dimension n.

In at least some embodiments, the testing resource matrix 210, the test coverage matrix 220, and a the TCTR matrix 301 are binary matrices in which each element has a value of either 1 or 0. For TCTR matrix 301, each element of the n-dimension vector indicates whether the applicable test run is included in the TCTR tuples. For the test coverage matrix 220 each element of the matrix indicates whether a particular test run, indicated by the row number, was able to reach a particular trace point indicated by the column number. Each element of the testing resource matrix 210, illustrated in more detail in FIG. 4, indicates whether a particular testing resource, indicated by column number, was used during a particular test run, indicated by the row number. FIG. 4 illustrates a particular example in which three independently functional testbeds (b=3) are used in a regression test that involves five test cases. Each test case is executed on each of the three test resources before proceeding to the nest test case. In this example, the number of test runs is 15 and testing resource 210 is a 15×3 matrix. Each of the three testing resources is represented as a one-hot vector of dimension 3, i.e., a vector of dimension 3 where one element of the vector is equal to one and the other elements of the vector are 0.

To determine the TCTR vector 301, the matrix representations of regression testing data are used to determine a test coverage score and a total duration for any or all of the possible TCTR tuples. The test coverage score is determined based on the test coverage equation 501 illustrated in FIG. 5 where the helper function b(Y) is defined as a binarization matrix Y: if Y_ij>0 then b(Y)_ij=1 else b(Y)_ij=0.

The total duration is determined based on the duration equation 601 of FIG. 6, where the value U is a vector of dimension n (the number of test runs) and the final test duration is t(X)=max(U).

FIG. 7 illustrates an exemplary determination of test duration using the equation 601 of FIG. 6, where the scalar values d1, d2, etc. represent the duration of the corresponding test run.

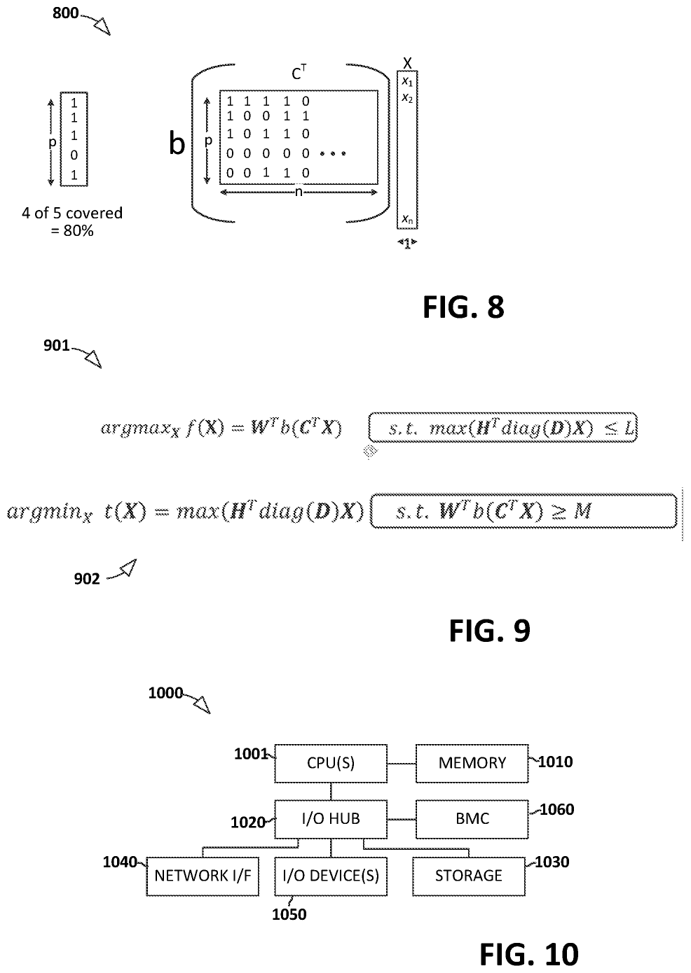

FIG. 8 illustrates a determination of the coverage score f(x) in accordance with equation 501 of FIG. 5 wherein the weighting matrix, W, which is optional, is omitted.

FIG. 9 illustrates constraint-limited optimizations of test coverage and test duration in accordance with disclosed teachings. Equation 901 indicates an optimization of TCTR tuples to achieve a maximum test coverage value f(x) for a specified maximum test time duration (L) while equation 902 indicates an optimization of TCTR tuples to achieve a minimum test time t(x) given a specified minimum test coverage value M.

Referring now to FIG. 10, any one or more of the elements illustrated in FIG. 1 through FIG. 9 may be implemented as or within an information handling system exemplified by the information handling system 1000 illustrated in FIG. 10. The illustrated information handling system includes one or more general purpose processors or central processing units (CPUs) 1001 communicatively coupled to a memory resource 1010 and to an input/output hub 1020 to which various I/O resources and/or components are communicatively coupled. The I/O resources explicitly depicted in FIG. 10 include a network interface 1040, commonly referred to as a NIC (network interface card), storage resources 1030, and additional I/O devices, components, or resources 1050 including as non-limiting examples, keyboards, mice, displays, printers, speakers, microphones, etc. The illustrated information handling system 1000 includes a baseboard management controller (BMC) 1060 providing, among other features and services, an out-of-band management resource which may be coupled to a management server (not depicted). In at least some embodiments, BMC 1060 may manage information handling system 1000 even when information handling system 1000 is powered off or powered to a standby state. BMC 1060 may include a processor, memory, an out-of-band network interface separate from and physically isolated from an in-band network interface of information handling system 1000, and/or other embedded information handling resources. In certain embodiments, BMC 1060 may include or may be an integral part of a remote access controller (e.g., a Dell Remote Access Controller or Integrated Dell Remote Access Controller) or a chassis management controller.

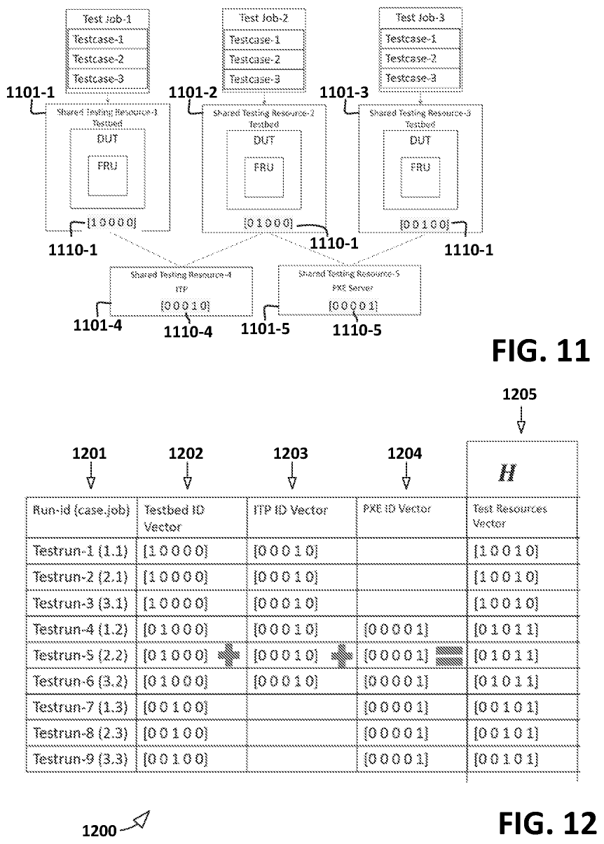

Referring now to FIG. 11 and FIG. 12, an example test configuration depicting the use of shared test resources is illustrated. As depicted in FIG. 11, a test platform 1100 includes five test resources 1101-1 through 1101-5 including a first testbed 1101-1, a second testbed 1101-2, a third testbed 1101-3, an ITP 1101-4, and a PE server 1101-5. In the depicted configuration, ITP 1101-4 is shared with first testbed 1101-1 and second testbed 1101-2 while PE server 1101-5 is shared with second testbed 1101-2 and third test bed 1101-3.

Each test resource 1101-1 through 1101-5 is assigned a corresponding one-hot ID vector 1110 of dimension five such that the ID vector 1110-1 for first testbed 1101-1 is [1 0 0 0 0], the ID vector 1110-2 for second testbed 1101-2 [0 1 0 0 0], the ID vector 1110-3 for third testbed 1101-3, and so forth.

FIG. 11 and FIG. 12 depict an example regression test in which each of three test cases (Testcase-1, Testcase-2, Testcase-3) is executed in each of three test jobs (Test Job-1, Test Job-2, and Test Job-3) including a Test Job corresponding to each testbed, for a total of nine test runs. FIG. 12 depicts a table 1200 including a column 1201 for test run ID, a column 1202 for the test bed ID vector, a column 1203 for the ITP ID vector, a column 1204 for the PXE server ID vector, and a shared testing resource column 1205 wherein, which is obtained by adding the ID vectors in columns 1202, 1203, and 1204. The testing resource matrix for this shared-resource example is the 9×5 matrix consisting of the nine shared testing resource vectors in column 1205 of table 1200. This testing resource matrix is the shared-resource analogy of the testing matrix 210 of FIG. 2.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A method for testing information handling system software, the method comprising:
identifying trace points, test cases, and test resources for testing the software;
performing a full test of the software to obtain test information including test coverage information indicative of traces points reached by each test case and test duration information indicative to time required to perform each test case, wherein the full test include performing each test case on each test resource;
determining, based on the test information, optimized test case, test resource (TCTR) tuples for efficiently testing the software, wherein the optimized TCTR tuples, when executed, achieve greater coverage per time interval than the full test.

2. The method of claim 1, wherein performing the full test includes executing each test case on each testing resource.

3. The method of claim 1, wherein determining the optimized TCTR tuples includes:
defining matrix representations of the testing resources, the test coverage, and the test duration;
calculating a coverage score and test duration for each TCTR tuple;
identifying the optimized TCTR information based on the coverage scores and test durations.

4. The method of claim 3, wherein defining matrix representations includes:
defining a one hot vectors for each testing resource.

5. The method of claim 3, wherein determining the optimized TCTR tuples includes determining TCTR tuples that produce the highest coverage score for a specified maximum duration.

6. The method of claim 3, wherein determining the optimized TCTR tuples include determining TCTR tuples producing the lowest test duration for specified minimum test coverage.

7. An information handling system, comprising:
a central processing unit (CPU);
a memory accessible to the CPU including processor executable instructions that, when executed by the CPU, cause the system to performing testing operations comprising:
identifying trace points, test cases, and test resources for testing the software;
performing a full test of the software to obtain test information including test coverage information indicative of traces points reached by each test case and test duration information indicative to time required to perform each test case, wherein the full test include performing each test case on each test resource;
determining, based on the test information, optimized test case, test resource (TCTR) tuples for efficiently testing the software, wherein the optimized TCTR tuples, when executed, achieve greater coverage per time interval than the full test.

8. The information handling system of claim 7, wherein performing the full test includes executing each test case on each testing resource.

9. The information handling system of claim 7, wherein determining the optimized TCTR tuples includes:
defining matrix representations of the testing resources, the test coverage, and the test duration;
calculating a coverage score and test duration for each TCTR tuple;
identifying the optimized TCTR information based on the coverage scores and test durations.

10. The information handling system of claim 9, wherein defining matrix representations includes:
defining a one hot vectors for each testing resource.

11. The information handling system of claim 9, wherein determining the optimized TCTR tuples includes determining TCTR tuples that produce the highest coverage score for a specified maximum duration.

12. The information handling system of claim 9, wherein determining the optimized TCTR tuples include determining TCTR tuples producing the lowest test duration for specified minimum test coverage.
